(19) United States
(12) Patent Application Publication
(10) Pub. No.: US 2007/0291688 A1
(43) Pub. Date: Dec. 20, 2007

(54) Method and apparatus of handling packet data in a wireless communications system

(75) Inventors: Sam Shiaw-Shiang Jiang, (US); Li-Chih Tseng, (US)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/812,217

(22) Filed: Jun. 15, 2007

Related U.S. Application Data
(60) Provisional application No. 60/805,096, filed on Jun. 19, 2006.

(51) Int. Cl. H04Q 7/00

(52) U.S. Cl. 370/328

(57) ABSTRACT

A method of handling packet data in a wireless communications system includes activating a hybrid automatic repeat request process, determining whether each of a plurality of packets to be transmitted is a signaling message or a control message, and setting maximum number of transmissions for a first packet of the plurality of packets to be 1 when the first packet is determined to be a signaling message or a control message.

### CROSS REFERENCE TO RELATED APPLICATIONS

This application claims the benefit of U.S. Provisional Application No. 60/805,096, filed on Jun. 19, 2006 and entitled “Method and Apparatus for Signaling Transmission on HARQ Processes with Bit Correlation”, the contents of which are incorporated herein by reference.

### BACKGROUND OF THE INVENTION

1. Field of the Invention

The present invention relates to a method and apparatus of handling packets in a wireless communications system, and more particularly, to a method and apparatus capable of enhancing utilization of radio resources.

2. Description of the Prior Art

The third generation mobile telecommunication technology provides High Speed Downlink Package Access (HSDPA) and High Speed Uplink Package Access (HSUPA) functions, which are used to increase bandwidth utility rate and package data processing efficiency to improve uplink/downlink transmission rate. In HSDPA, after receiving packet data units (PDUs) from a network end (UTRAN), the user equipment (UE) stores the PDUs in a soft buffer or discards them based on a status of a previous transmission. Then, the UE decodes the stored PDUs and performs scheduling for multiple decoded PDUs received from several transmissions. In order to quickly determine whether a PDU received by the UE comprises new data, a Medium Access Control (MAC) specification, 3GPP TS 25.321 V7.0.0, developed by the 3rd Generation partnership Project (3GPP), defines a new data indicator (NDI), having a value of 1 or 0, for indicating that a transmission is a new transmission or a retransmission with respect to the previous transmission.

According to the aforementioned MAC specification, every time a new transmission is being established, such as after receiving an ACK (positive acknowledgement signal) from the UE, the UTRAN increments the previous NDI value by one and then sends the updated NDI for the new transmission. On the contrary, when establishing a retransmission, such as receiving a NACK (negative acknowledgement signal) from the UE, the UTRAN uses the same NDI. Thus, if the UE receives NDIs having different values, such as ‘1’ ‘0’ or ‘1’ ‘1’, in two consecutive transmissions, the latter transmission is regarded as a new transmission with respect to the former one. The UE then decodes the PDUs of the latter transmission and stores the PDUs in the soft buffer to replace originally existing data. Oppositely, if the UE receives the NDIs having the same values, such as ‘0’ ‘0’ or ‘1’ ‘1’, in the two consecutive transmissions, the latter transmission is regarded as a retransmission of the former one. In such a situation, if the former transmission was decoded unsuccessfully, the UE performs soft combining on the PDUs of the latter transmission and the data in the soft buffer. Oppositely, if the former transmission has been decoded successfully, the UE delivers the data in the soft buffer to an upper entity such as a reordering entity, and returns an ACK. In addition, the PDU of the latter transmission is discarded by the UE.

Therefore, if the UE receives the NDIs having the same values in the two consecutive transmissions and the former transmission has been decoded successfully, the UE delivers the data in the soft buffer to an upper entity, returns an ACK, and discards the PDU of the latter transmission. However, if a certain transmission error, such as discontinuous transmission to acknowledgement (DTX_to_ACK) error, occurs, the HARQ process may cause the UE to miss useful PDUs, resulting in incomplete collection of data blocks in the upper layer (e.g., Radio Link Control layer). The following example explains such an erroneous situation in detail.

Please refer to FIG. 1, which is a schematic diagram of an HARQ process for transmitting packets in HSDPA according to the prior art. In FIG. 1, assume that a UTRAN (network end) prepares four PDUs for a UE in an HARQ process and sends corresponding NDIs for each transmission. The transmission sequence numbers (TSNs) of the PDUs are 8, 12, 18, and 24, respectively. In the beginning, the UTRAN transmits the PDU with NDI=0 and TSN=8. The UE stores the PDU in a soft buffer after receiving and decoding the PDU successfully, and thereby returns an ACK to the UTRAN. Due to the ACK reported, the UTRAN then transmits the PDU with NDI=1 and TSN=12 to the UE. Meanwhile, the transmission error DTX_to_ACK occurs, meaning that the PDU with TSN=12 is lost during transmission while the UTRAN receives an ACK for the PDU with TSN=12 because of radio interference. In this situation, the UTRAN mistakenly determines that the UE has successfully received the PDU with NDI=1 and TSN=12, and subsequently transmits the PDU with NDI=0 and TSN=18. From the standpoint of the UE, the PDUs with TSN=8 and TSN=18 have the same NDI value, so the PDU with TSN=18 is considered as a retransmission of the PDU with TSN=8. According to the foregoing MAC specification, since the PDU with TSN=8 has been successfully decoded, the UE will deliver the data in the soft buffer, which includes the PDU with TSN=8, to the upper layer, return an ACK to the UTRAN, and discard the PDU (with NDI=0 and TSN=18) mistakenly determined to be a retransmission. Therefore, the UTRAN determines that the UE has successfully received the PDU with TSN=18, and subsequently transmits the PDU with TSN=24. As a result, the UE misses the PDU with TSN=18 and the upper layer cannot completely collect and reconstruct the data blocks.

In addition, along with each transmission of a PDU, at least one bit for the NDI need to be transmitted on a control channel, of which the resource is limited and valuable. The overhead of this kind of out-band signaling is quite high.

On the other hand, the HARQ process is an asynchronous ARQ technology, which combines unsuccessfully decoded data to generate correct packets, so that transmission efficiency can be increased. However, due to this property, a packet transmitted latter may be received successfully by the receiver before another packet transmitted earlier, which may cause system errors. For example, in the HSUPA system, a Scheduling Information (SI) message is 18 bits long, and contains information of traffic volume and mobile's power headroom. If an SI message arrives the receiver after another newer SI message transmitted latter due to the HARQ property, the system may mistakenly distribute radio resources according to an older SI message, and transmission efficiency is deteriorated.

In order to solve the aforementioned problem, the applicant of the present invention has filed another U.S. Patent application “Method and Apparatus of Handling Packet Data in a Wireless Communications System” on May 24, 2007, which dose not use NDI, but calculates bit correlation values to determine whether two packets are different or the same, and is called the Bit Correlation method hereinafter because the corresponding application No. is not yet received when filing this application. Using the Bit Correlation method, if a bit correlation value between data of two successive packets is smaller than a threshold value, the two packets are determined to be different; if the bit correlation value is greater than or equal to the threshold value, the two packets are determined to be the same. In such situation, even if the transmission error DTX_to_ACK occurs, the Bit Correlation method does not miss useful PDUs, and can timely trigger retransmission of the network. Besides, the overhead for NDI out-band signaling is removed, so that radio resource efficiency is improved.

The Bit Correlation method can work for data packets that have different contents. However, for some Layer 2 control or signaling messages, the content may be quite similar to each other. If the threshold value for the Bit Correlation method is not set properly, different packets may be mistakenly considered as identical packets. As an example, if there are only slight different between two SI messages transmitted on the same HARQ process contiguously, the bit correlation value between the SI messages will be greater than the threshold value. Therefore, the later received SI message is considered as a retransmission of the former one, so that the later one is discarded while an ACK is reported back.

In addition, in the third generation mobile telecommunication system, an RLC (Radio Link Control) entity may report status report units with information indicating its receiving status for the peer RLC entity. Since the status report units are not ciphered, bit correlation between two status report units transmitted on the same HARQ process contiguously might be quite high, or greater than the threshold value, so that the later received status report unit is discarded. As a result, the transmitter cannot determine the receiving status of the receiver.

### SUMMARY OF THE INVENTION

According to the present invention, a method of handling packet data in a wireless communications system comprises activating a hybrid automatic repeat request process, determining whether each of a plurality of packets to be transmitted is a signaling message or a control message, and setting maximum number of transmissions for a first packet of the plurality of packets to be 1 when the first packet is determined to be a signaling message or a control message.

According to the present invention, a communications device of a wireless communications system utilized for accurately handling packet data comprises a control circuit for realizing functions of the communications device, a central processing unit installed in the control circuit for executing a program code to operate the control circuit, and a memory coupled to the central processing unit for storing the program code. The program code comprises activating a hybrid automatic repeat request process, determining whether each of a plurality of packets to be transmitted is a signaling message or a control message, and setting maximum number of transmissions for a first packet of the plurality of packets to be 1 when the first packet is determined to be a signaling message or a control message.

According to the present invention, a method of handling packet data in a wireless communications system comprises activating a hybrid automatic repeat request process, receiving a plurality of packets, determining whether each of the plurality of packets is a data packet or a control message, and discarding a first packet of the plurality of packets when the first packet is a control message and is not successfully received.

According to the present invention, a communications device of a wireless communications system utilized for accurately handling packet data comprises a control circuit for realizing functions of the communications device, a central processing unit installed in the control circuit for executing a program code to operate the control circuit, and a memory coupled to the central processing unit for storing the program code. The program code comprises activating a hybrid automatic repeat request process, receiving a plurality of packets, determining whether each of the plurality of packets is a data packet or a control message, and discarding a first packet of the plurality of packets when the first packet is a control message and is not successfully received.

According to the present invention, a method of handling packet data in a wireless communications system comprises setting maximum number of transmissions for a data packet and a status report unit in a hybrid automatic repeat request process to be greater than 1, activating a first hybrid automatic repeat request process, and outputting a status report unit according to the maximum number of transmissions when the first hybrid automatic repeat request process matches a predefined condition.

According to the present invention, a communications device of a wireless communications system utilized for accurately handling packet data comprises a control circuit for realizing functions of the communications device, a central processing unit installed in the control circuit for executing a program code to operate the control circuit, and a memory coupled to the central processing unit for storing the program code. The program code comprises setting maximum number of transmissions for a data packet and a status report unit in a hybrid automatic repeat request process to be greater than 1, activating a first hybrid automatic repeat request process, and outputting a status report unit according to the maximum number of transmissions when the first hybrid automatic repeat request process matches a predefined condition.

According to the present invention, a method of outputting status report units in a wireless communications system comprises generating a plurality of status report messages according to a receiving status of packets, forming a plurality of status report units each comprises a padding field and one of the plurality of status report messages, and filling padding fields of the plurality of status report units with random number data.

According to the present invention, a communications device of a wireless communications system utilized for accurately outputting status report units comprises a control circuit for realizing functions of the communications device, a central processing unit installed in the control circuit for executing a program code to operate the control circuit, and a memory coupled to the central processing unit for storing the program code. The program code comprises generating a plurality of status report messages according to a receiving status of packets, forming a plurality of status report units each comprises a padding field and one of the plurality of status report messages, and filling padding fields of the plurality of status report units with random number data. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an HARQ process for transmitting packets in HSDPA according to the prior art.

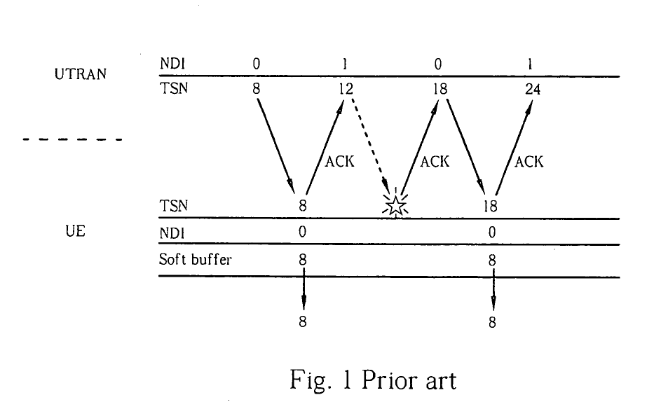

FIG. 2 is a function block diagram of a wireless communications device.

FIG. 3 is a diagram of program code of FIG. 2.

FIG. 4 is a flowchart of a process according to the first embodiment of the present invention.

FIG. 5 is a flowchart of a process according to the second embodiment of the present invention.

FIG. 6 is a flowchart of a process according to the third embodiment of the present invention.

FIG. 7 is a flowchart of a process according to the fourth embodiment of the present invention.

### DETAILED DESCRIPTION

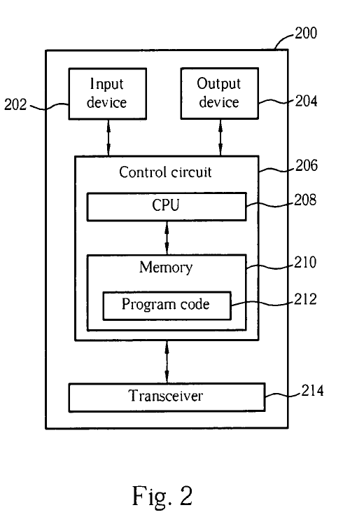

Please refer to FIG. 2, which is a functional block diagram of a communications device 200. For the sake of brevity, FIG. 2 only shows an input device 202, an output device 204, a control circuit 206, a central processing unit (CPU) 208, a memory 210, a program code 212, and a transceiver 214 of the communications device 200. In the communications device 200, the control circuit 206 executes the program code 212 in the memory 210 through the CPU 208, thereby controlling operation of the communications device 200. The communications device 200 can receive signals input by a user through the input device 202, such as a keyboard, and can output images and sounds through the output device 204, such as a monitor or speakers. The transceiver 21 4 is used to receive and transmit wireless signals, delivering received signals to the control circuit 206, and outputting signals generated by the control circuit 206 wirelessly. From a perspective of a communications protocol framework, the transceiver 214 can be seen as a portion of Layer 1, and the control circuit 206 can be utilized to realize functions of Layer 2 and Layer 3.

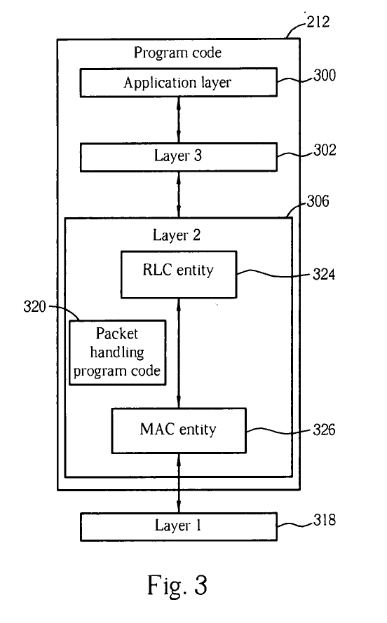

Please continue to refer to FIG. 3, which is a diagram of the program code 212 shown in FIG. 2. The program code 212 includes an application layer 300, a Layer 3 302, and a Layer 2 306, and is coupled to a Layer 1 318. The Layer 2 306 comprises two sub-layers: a radio link control (RLC) entity 324 and a media access control (MAC) entity 326. The MAC entity 326 can match packets received from different logic channels of the RLC entity 324 to common, shared, or dedicated transport channels according to radio resource allocation commands of the Layer 3 (RRC layer) 302, for performing channel mapping, multiplexing, transport format selection, or random access control.

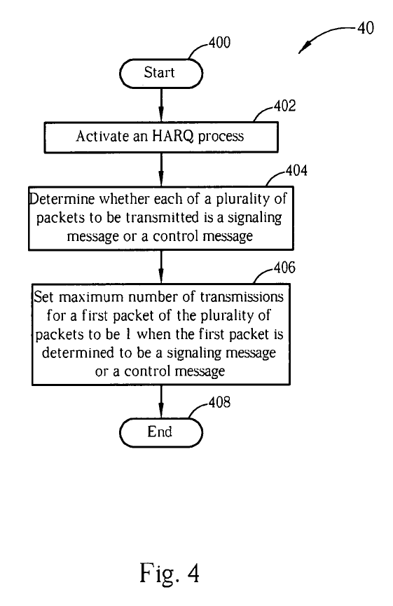

Preferably, the communications device 200 is applied to a third generation (3G) mobile communications system, and utilizes the program code 21 2 to execute the HARQ process. Therefore, the present invention provides a packet handling program code 320 for properly handling packets to enhance radio resource utility. Please refer to FIG. 4, which is a schematic diagram of a process 40 according. to a first embodiment of the present invention. The process 40 is utilized for handling packets in a transmitter of a wireless communications system, and can be compiled into the packet handling program code 320. The process 40 includes the following steps:
Step 400: Start.
Step 402: Activate an HARQ process.
Step 404: Determine whether each of a plurality of packets to be transmitted is a signaling message or a control message.
Step 406: Set maximum number of transmissions for a first packet of the plurality of packets to be 1 when the first packet is determined to be a signaling message or a control message.
Step 408: End.

According to the process 40, the first embodiment of the present invention transmits a signaling message or a control message for once. That is, the same signaling message or control message can be transmitted for one time, so that each signaling message or control message must be different from other signaling messages or control messages. In such situation, adjacent signaling messages or control messages are different, and thus, the receiver need not use NDI or calculate bit correlation values. Therefore, the first embodiment of the present invention can avoid the signaling messages, such as SI messages, or the control messages, such as status report units, from being unnecessarily discarded, so as to enhance radio resource utility.

In other words, when a signaling message or control message is not successfully transmitted, the first embodiment of the present invention does not trigger retransmission, but transmits a new signaling message or control message instead. Preferably, the first embodiment of the present invention can further set maximum number of transmissions for a data packet to be greater than 1. As a result, when a NACK corresponding to a data packet is received, the transmitter can retransmit the data packet, so as to enhance transmission efficiency.

Through the process 40, the transmitter transmits a signaling message or control message for one time, so that the receiver can determine that the received signaling message or control message must be different from other signaling messages or control messages without NDI and bit correlation values. Therefore, radio resource utility can be enhanced.

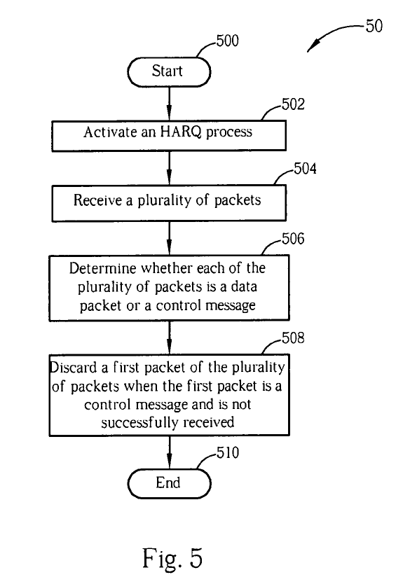

Please refer to FIG. 5, which is a schematic diagram of a process 50 according to a second embodiment of the present invention. The process 50 is utilized for handling packets in a receiver of a wireless communications system, and can be compiled into the packet handling program code 320. The process 50 includes the following steps:
Step 500: Start.
Step 502: Activate an HARQ process
Step 504: Receive a plurality of packets.
Step 506: Determine whether each of the plurality of packets is a data packet or a control message.
Step 508: Discard a first packet of the plurality of packets when the first packet is a control message and is not successfully received.
Step 510: End.

According to the process 50, in an HARQ process, if a packet is determined to be a control message and if the packet is not successfully received, the packet is discarded. Oppositely, if a packet received by the receiver is determined to be a data packet, the Bit Correlation method can be applied to determine whether the packet is different from the formerly received data packet or not.

In other words, if a control message is not successfully received in an HARQ process, the receiver discards the control message; if a data packet is received, the receiver calculates a bit correlation value between the data packet and a former data packet, so to determine whether the data packet is a new transmission or a retransmission. Preferably, the second embodiment of the present invention can determine whether a packet is successfully received through a Cyclic Redundancy Check (CRC) operation, and return a NACK corresponding to a packet to the transmitter for triggering retransmission if the packet is not successfully received. In addition, preferably, the second embodiment of the present invention does not output any acknowledgement signal, including positive and negative acknowledgement signals, corresponding to a control message.

Therefore, through the process 50, in an HARQ process, the second embodiment of the present invention discards unsuccessfully received control messages, and preferably, the second embodiment of the present invention does not output any acknowledgement signal corresponding to a control message. Oppositely, if a data packet is received, the receiver can determine whether the data packet is a new transmission or a retransmission by the Bit Correlation method. As a result, accuracy of the Bit Correlation method is upgraded, and control messages will not be unnecessarily discarded, so as to enhance radio resource utility.

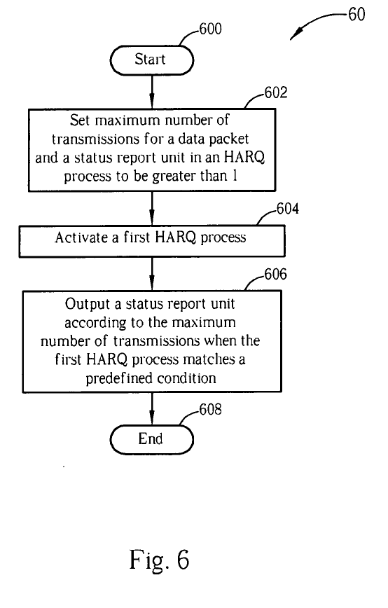

Please refer to FIG. 6, which is a schematic diagram of a process 60 according to a third embodiment of the present invention. The process 60 is utilized for handling packets in a receiver of a wireless communications system, and can be compiled into the packet handling program code 320. The process 60 includes the following steps:
Step 600: Start.
Step 602: Set maximum number of transmissions for a data packet and a status report unit in an HARQ process to be greater than 1.
Step 604: Activate a first HARQ process.
Step 606: Output a status report unit according to the maximum number of transmissions when the first HARQ process matches a predefined condition.
Step 608: End.

According to the process 60, in an HARQ process, maximum number of transmissions for a data packet and a status report unit is greater than 1, meaning that the data packet and the status report unit can be retransmitted. And the receiver transmits the status report unit only when the corresponding HARQ process matches the predefined condition.

The predefined condition is preferably one of the following conditions: 1) the first HARQ process has not transmitted any data, 2) the first HARQ process has not transmitted any data for a predefined duration of time, and 3) the length of a previous transmitted data on the first HARQ process is different from the length of the status report unit. When the first HARQ process matches the predefined condition, the receiver can output the status report unit, and thus, the status report unit will not be unnecessarily discarded.

For example, if an HARQ process has not transmitted any data (for the predefined duration of time), a status report unit outputted from the receiver must be a new status report unit. Therefore, without using NDI or calculating the bit correlation value, the transmitter can accurately determine that the received status report unit is a new transmission, and thus, the status report unit will not be discarded. In addition, if the length of a previous transmitted data on an HARQ process is different from the length of the status report unit, the status report unit can be determined to be a new transmission due to the different lengths, and will not be discard accordingly.

Therefore, through the process 60, the third embodiment of the present invention outputs the status report unit when the corresponding HARQ process matches the predefined condition, and the status report unit can be retransmitted if necessary. In such situation, the status report unit will not be unnecessarily discarded, and radio resource utility can be enhanced.

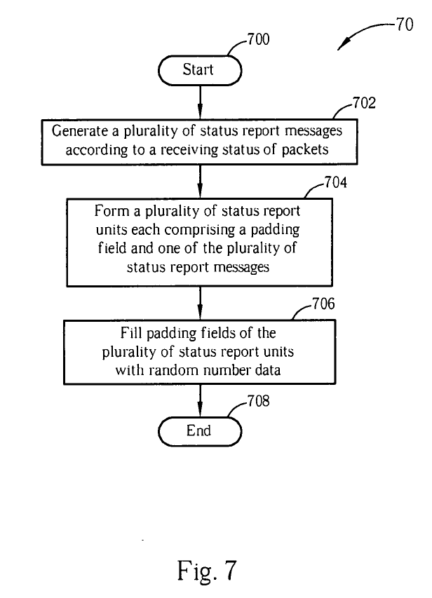

Please refer to FIG. 7, which is a schematic diagram of a process 70 according to a fourth embodiment of the present invention. The process 70 is utilized for outputting status report units in a receiver of a wireless communications system, and can be compiled into the packet handling program code 320. The process 70 includes the following steps:
Step 700: Start.
Step 702: Generate a plurality of status report messages according to a receiving status of packets.
Step 704: Form a plurality of status report units each comprising a padding field and one of the plurality of status report messages.
Step 706: Fill padding fields of the plurality of status report units with random number data.
Step 708: End.

According to the process 70, the padding fields of the status report units are filled with random number data. Therefore, bit correlation value between padding fields of adjacent status report units is quite low because there is no counting rule within ideal random number data. As a result, even if status report messages of two consecutive status report units are almost the same, the Bit Correlation method still determines that the status report units are different due to low bit correlation value between their padding fields. In such situation, maximum number of transmissions and transmitting conditions for the status report units are not limited, so that the transmitter can accurately determine receiving status of the receiver.

Therefore, through the process 70, the fourth embodiment of the present invention fills the padding fields of the status report units with random number data, so as to decrease bit correlation value between adjacent status report units, and thus, the peer entity can utilize the Bit Correlation method to determine that the adjacent status report units are different, avoid unnecessary discard, and enhance radio resource utility.

In summary, using the above-mentioned four embodiments, the present invention can prevent the control messages or signaling messages from being unnecessarily discarded, so as to upgrade accuracy and practicability of the Bit Correlation method, and enhance radio resource utility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling packet data in a wireless communications system comprising:
activating a hybrid automatic repeat request process;
determining whether each of a plurality of packets to be transmitted is a signaling message or a control message; and
setting maximum number of transmissions for a first packet of the plurality of packets to be 1 when the first packet is determined to be a signaling message or a control message.

2. The method of claim 1 further comprising setting maximum number of transmissions for a second packet of the plurality of packets to be greater than 1 when the second packet is neither a signaling message nor a control message.

3. The method of claim 2 further comprising retransmitting the second packet when receiving a negative acknowledgement signal corresponding to the second packet.

4. The method of claim 1 further comprising outputting a third packet different from the first packet when receiving a negative acknowledgement signal corresponding to the first packet.

5. The method of claim 4, wherein the third packet comprises at least an updated signaling message or an updated control message.

6. A communications device of a wireless communications system utilized for accurately handling packet data comprising:
a control circuit for realizing functions of the communications device;
a central processing unit installed in the control circuit for executing a program code to operate the control circuit; and
a memory coupled to the central processing unit for storing the program code;
wherein the program code comprises:
activating a hybrid automatic repeat request process;
determining whether each of a plurality of packets to be transmitted is a signaling message or a control message; and
setting maximum number of transmissions for a first packet of the plurality of packets to be 1 when the first packet is determined to be a signaling message or a control message.

7. The communications device of claim 6, wherein the program code further comprises setting maximum number of transmissions for a second packet of the plurality of packets to be greater than 1 when the second packet is neither a signaling message nor a control message.

8. The communications device of claim 7, wherein the program code further comprises retransmitting the second packet when receiving a negative acknowledgement signal corresponding to the second packet.

9. The communications device of claim 6, wherein the program code further comprises outputting a third packet different from the first packet when receiving a negative acknowledgement signal corresponding to the first packet.

10. The communications device of claim 9, wherein the third packet comprises at least an updated signaling message or an updated control message.

11. A method of handling packet data in a wireless communications system comprising:
activating a hybrid automatic repeat request process;
receiving a plurality of packets;
determining whether each of the plurality of packets is a data packet or a control message; and
discarding a first packet of the plurality of packets when the first packet is a control message and is not successfully received.

12. The method of claim 11 further comprising determining whether each of the plurality of packets is a data packet according to the packet lengths of the plurality of packets.

13. The method of claim 11 further comprising determining whether each of the plurality of packets is received successfully according to a Cyclic Redundancy Check operation.

14. The method of claim 11 further comprising calculating a bit correlation value between a second packet of the plurality of packets and a third packet for determining whether the second packet is a retransmission of the third packet when the second packet is determined to be a data packet.

15. The method of claim 14, wherein the third packet is a formerly received data packet before the second packet.

16. The method of claim 11 further comprising prohibiting transmission of any acknowledgement signals corresponding to a packet of the plurality of packets when the packet is determined to be a control message.

17. The method of claim 11 further comprising outputting a negative acknowledgement signal corresponding to a packet of the plurality of packets when the packet is not successfully received.

18. A communications device of a wireless communications system utilized for accurately handling packet data comprising:
a control circuit for realizing functions of the communications device;
a central processing unit installed in the control circuit for executing a program code to operate the control circuit; and
a memory coupled to the central processing unit for storing the program code;
wherein the program code comprises:
activating a hybrid automatic repeat request process;
receiving a plurality of packets;
determining whether each of the plurality of packets is a data packet or a control message; and
discarding a first packet of the plurality of packets when the first packet is a control message and is not successfully received.

19. The communications device of claim 18, wherein the program code further comprises determining whether each of the plurality of packets is a data packet according to the packet lengths of the plurality of packets.

20. The communications device of claim 18, wherein the program code further comprises determining whether each of the plurality of packets is received successfully according to a Cyclic Redundancy Check operation.

21. The communications device of claim 18, wherein the program code further comprises calculating a bit correlation value between a second packet of the plurality of packets and a third packet for determining whether the second packet is a retransmission of the third packet when the second packet is determined to be a data packet.

22. The communications device of claim 21, wherein the third packet is a formerly received data packet before the second packet.

23. The communications device of claim 18, wherein the program code further comprises prohibiting transmission of any acknowledgement signals corresponding to a packet of the plurality of packets when the packet is determined to be a control message.

24. The communications device of claim 18, wherein the program code further comprises outputting a negative acknowledgement signal corresponding to a packet of the plurality of packets when the packet is not successfully received.

25. A method of handling packet data in a wireless communications system comprising:
setting maximum number of transmissions for a data packet and a status report unit in a hybrid automatic repeat request process to be greater than 1;
activating a first hybrid automatic repeat request process; and
outputting a status report unit according to the maximum number of transmissions when the first hybrid automatic repeat request process matches a predefined condition.

26. The method of claim 25, wherein the predefined condition is that the first hybrid automatic repeat request process has not transmitted any data.

27. The method of claim 25, wherein the predefined condition is that the length of a previous transmitted data on the first hybrid automatic repeat request process is different from the length of the status report unit.

28. The method of claim 25, wherein the predefined condition is that the first hybrid automatic repeat request process has not transmitted any data for a predefined duration of time.

29. A communications device of a wireless communications system utilized for accurately handling packet data comprising:
a control circuit for realizing functions of the communications device;
a central processing unit installed in the control circuit for executing a program code to operate the control circuit; and
a memory coupled to the central processing unit for storing the program code;
wherein the program code comprises:
setting maximum number of transmissions for a data packet and a status report unit in a hybrid automatic repeat request process to be greater than 1;
activating a first hybrid automatic repeat request process; and
outputting a status report unit according to the maximum number of transmissions when the first hybrid automatic repeat request process matches a predefined condition.

30. The communications device of claim 29, wherein the predefined condition is that the first hybrid automatic repeat request process has not transmitted any data.

31. The communications device of claim 29, wherein the predefined condition is that the length of a previous transmitted data on the first hybrid automatic repeat request process is different from the length of the status report unit.

32. The communications device of claim 29, wherein the predefined condition is that the first hybrid automatic repeat request process has not transmitted any data for a predefined duration of time.

33. A method of outputting status report units in a wireless communications system comprising:
generating a plurality of status report messages according to a receiving status of packets;
forming a plurality of status report units, each comprising a padding field and one of the plurality of status report messages; and
filling padding fields of the plurality of status report units with random number data.

34. A communications device of a wireless communications system utilized for accurately outputting status report units comprising:
a control circuit for realizing functions of the communications device;
a central processing unit installed in the control circuit for executing a program code to operate the control circuit; and
a memory coupled to the central processing unit for storing the program code;
wherein the program code comprises:
generating a plurality of status report messages according to a receiving status of packets;
forming a plurality of status report units, each comprising a padding field and one of the plurality of status report messages; and
filling padding fields of the plurality of status report units with random number data.
